(19) United States
(12) Patent Application Publication
(10) Pub. No.: US 2026/0235659 A1
(43) Pub. Date: Aug. 13, 2026

(54) DISTRIBUTED FEDERATED LEARNING OF SEMICONDUCTOR PARAMETERS FOR ENHANCED MANUFACTURING AND DESIGN

(71) Applicant: Tektronix, Inc., Beaverton, OR (US)

(72) Inventors: Keith R. Tinsley, Eugene, OR (US); William C. Weeman, Aurora, OH (US); Douglas R. Crocker, Corvallis, OR (US)

(73) Assignee: Tektronix, Inc., Beaverton, OR (US)

(21) Appl. No.: 19/535,109

(22) Filed: Feb. 10, 2026

Related U.S. Application Data
(60) Provisional application No. 63/758,052, filed on Feb. 13, 2025.

(51) Int. Cl. G01R 31/26; G06N 20/00

(52) U.S. Cl. CPC G01R 31/2642; G06N 20/00

(57) ABSTRACT

A test and measurement system includes a network and multiple nodes coupled to the network. Each node incorporates a device under test (DUT), one or more test and measurement instruments, one or more artificial intelligence (AI) models, and one or more processors. The processors are configured to generate measurement training data from the DUT using the test and measurement instruments, train the AI models using the measurement training data, and determine a predictive estimate of a performance metric of the DUT based on outputs of the AI models. The system enables distributed or federated learning across nodes without centralizing raw DUT measurements, allowing each node to refine model parameters locally while optionally sharing model updates. By leveraging locally generated measurement data and AI-based predictive analytics, the system enhances device characterization, reliability assessment, and design workflows while reducing data-handling burdens and preserving device-specific confidentiality.

### CROSS-REFERENCE TO RELATED APPLICATIONS

This disclosure claims priority to U.S. Provisional Patent Application No. 63/758,052, titled “DISTRIBUTED FEDERATED LEARNING OF SEMICONDUCTOR PARAMETERS FOR ENHANCED MANUFACTURING AND DESIGN,” filed on Feb. 13, 2025, the disclosure of which is incorporated herein by reference in its entirety.

### TECHNICAL FIELD

This disclosure relates to test and measurement instruments and systems, and more particularly to testing of semiconductor or device electronic components, systems, or platforms.

### BACKGROUND

Semiconductor devices, such as power metal–oxide–semiconductor field‑effect transistors (MOSFETs) and other field-effect transistors, are typically evaluated and characterized using electrical test and measurement equipment. Instruments such as source measure units (SMUs) are used to perform current-voltage measurements and other metrology functions for purposes including device qualification, reliability assessment, and manufacturing control. Conventionally, measurement data collected from these instruments is processed in centralized environments where device models—such as Simulation Program with Integrated Circuit Emphasis (SPICE) based compact models—are generated or refined.

As semiconductor devices have become more complex and are produced across diverse manufacturing environments, increasing interest has developed in the use of data-driven techniques, including artificial intelligence and machine learning, to characterize device behavior. These techniques may require large quantities of device-specific measurement data collected under a variety of operating conditions. However, the collection and aggregation of such data in a single centralized repository may present technical challenges, including bandwidth limitations, latency, and the handling of sensitive or proprietary device information.

Efforts have been made in the industry to explore distributed approaches to model development. For example, certain research describes the use of edge-based test and measurement architectures to obtain electrical measurements suitable for predictive modeling of parameters such as gate leakage or indicators of long-term reliability. Other work has examined the use of machine-learning techniques for lifecycle assessment, such as predicting remaining useful lifetime (RUL) or other performance-maintenance-health metrics. Still other systems explore data aggregation strategies for centralized artificial-intelligence processing of semiconductor device information.

Notwithstanding these developments, existing approaches generally rely on either fully centralized data processing or architectures in which large volumes of device-level measurement data must be transferred to a central system. These paradigms may limit scalability or present challenges where different stakeholders—such as semiconductor manufacturers, integrators, or test-equipment operators—maintain separate datasets that cannot be readily combined due to privacy, confidentiality, or data-handling constraints. As a result, there remains a need for technical solutions that allow measurement-driven device models to be generated from distributed data sources while reducing the need to centralize raw device measurements, easing data retention and transport requirements.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 shows a system diagram of an artificial intelligence-based system for test and measurement, according to some examples.

FIG. 2 is a diagram showing example test and measurement instruments coupled to a DUT for the node of FIG. 1, according to some examples.

FIG. 3 is a diagram showing a topology for the artificial intelligence-based system of FIG. 1, according to some examples.

FIG. 4 is a flowchart of operations performed by a node of the distributed federated system of FIG. 1, according to some examples.

FIG. 5 is a block diagram of the environment of a distributed federated system as described herein, according to some examples.

FIG. 6 is a graph showing predictive assessments compared to actual assessments, according to some examples.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Examples of the disclosure have applications that span the field related to semiconductor or device electronic components, systems, or platforms. Specifically, in these fields, examples of the disclosure deliver enhanced intelligence along multiple points in a workflow continuum: design, manufacturing, deployment (integration), and sustainment (reliability assurance).

Examples of the disclosure, applications of the examples, and inferred resultants (insights and actions), applied in whole or in part, seek to use a disaggregated computational intelligence to learn interface characteristics through physical metrological measurements, formulating them into, but not limited to, Artificial Intelligence or Machine Learning models. These models are used to affect manufacturing and design decisions through the availability of physical, real-time measures, forming a closed loop with earlier workflow steps.

Examples of the disclosure delve into the transformative potential of distributed and federated learning in advancing Artificial Intelligence characterizing semiconductor devices. Examples harness the power of machine learning (ML) to construct sophisticated models for predictive performance assessments, targeting knowledge for risk mitigation at various upstream (i.e., previous) stages, i.e., design, planning, or semiconductor manufacturing.

The primary objective of these ML-driven outputs, associated with artificial intelligence models, is tied to semiconductor processing workflows of, but not limited to, planning, design, manufacturing, or deployment (product integration), by offering predictive insights into various parameters for the DUTs, such as the life-cycle outcomes of semiconductor devices. Notably, this includes enhancing Accelerated Life Assessments (ALA), which are crucial for evaluating the longevity and reliability of semiconductor components.

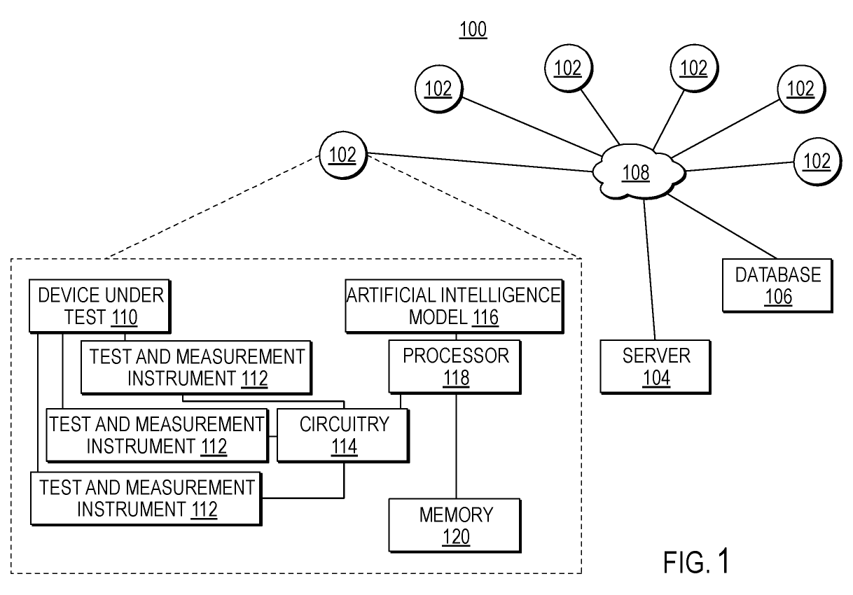

FIG. 1 shows a system diagram of an artificial intelligence-based system for test and measurement, according to some examples. The examples herein involve a test and measurement system comprised of a network of nodes, one or more central servers, and a database. Some examples may include a large language model (LLM) interface to the database. Some examples have nodes comprised of test and measurement instruments. Most, if not all, nodes have processing capability that allows the node to operate a generative adversarial network (GAN). The nodes with processing capabilities may also be configured to employ federated learning.

FIG. 1 shows a system diagram of an artificial intelligence-based system for test and measurement, according to some examples. The system 100 includes a network of nodes, like nodes 102, one or more servers like server 104, and one or more databases like database 106. The nodes 102, server 104, and the one or more databases 106 may be able to communicate with each other via a network 108, such as a cloud network, a local area network, or any other communication protocol that one of ordinary skill in the art would understand how to implement or use.

The server 104 may be referred to as a “centralized server” meaning that the server 104 communicates with many, if not all, of the nodes 102, not the physical location of the server 104. The server 104, as well as any nodes 102 that comprise a test and measurement instrument, may comprise one or more processors (not illustrated), a memory (not illustrated), a port (not illustrated) that allows the server 104 to communicate with one or more of the nodes 102. In some examples, the server 104 can be used for facilitating communication between the nodes 102 of the system 100 via the network 108. In some examples, the system 100 may not need the server 104 for facilitating communication between nodes 102, and instead, the nodes 102 of the system 100 can communicate with each other via the network 108 without the server 104.

The database 106 can be one or more databases that can store information of the system 100, including but not limited to the information produced by each of the nodes. The database 106 can be a remote storage or a local storage, and the system 100 can include any number of databases.

FIG. 1 also shows an example of a node that may reside in the network. The node 102 can include a device under test (DUT) 110, one or more artificial intelligence (AI) models 116, memory 120, a processor 118, circuitry 114, and one or more test and measurement instruments 112. As illustrated, the DUT 110 connects to one or more test and measurement instruments 112 through one or more channels (not illustrated). The DUT 110 produces signals that passes to the one or more test and measurement instruments 112. The one or more test and measurement instruments 112 receives the signal and undergoes signal processing and conditioning in either the one or more test and measurement instruments 112 or via the circuitry 114. This conditioning may include conversion from analog to digital, signal conditioning, timing adjustments, etc. Accordingly, the circuitry 114 includes any number or arrangement of circuit components for processing the signals from the DUT 110 and from the test and measurement instruments. In some examples, the node 102 also includes circuitry (not illustrated) between the DUT 110 and the test and measurement instruments, so that the test and measurement instruments 112 can accurately test and measure the DUT 110. The signal then is then sent to the one or more AI models 116 via the processor 118. In some examples, the test and measurement instruments 112 and/or processor 118 can provide further analysis of the conditioned signals before sending the results to the one or more AI models 116. This results, the conditioned signals, and the original signal may then be stored in memory 120.

The one or more AI models 116 can be a machine learning system, which may comprise a separate processor from a main processor that has undergone programming to operate a machine learning process, both of which are represented by processor 118. For purposes of this discussion, the term “artificial intelligence” (AI) refers to machine learning, meaning a neural network or other machine learning architecture that has undergone training, supervised or unsupervised, to produce an output, and “generative AI.” In some examples, the one or more AI models 116 used herein can be an artificial neural network.

In some examples, the node 102 can include a computing device with memory 120 and processor 118. Memory 120 may be implemented as processor cache, random access memory (RAM), read only memory (ROM), solid state memory, hard disk drive(s), or any other memory type. Memory acts as a medium for storing data, computer program products, and other instructions. Processor 118 may be implemented in order to perform actions, such as, but not limited to, facilitating communication with other nodes 102, facilitating communication between the one or more test and measurement instruments and the one or more AI models 116, storing data related to the one or more test and measurement instruments 112 and/or the one or more AI models 116 in memory 120. The computing device (not illustrated) can also include a user interface (not illustrated) coupled to the one or more processors 118. This user interface may include a display keyboard, mouse, trackball, touchscreen, and/or any other controls employable by a user to interact with a GUI on the display, which may a digital screen or any other monitor to display waveforms, measurements, and other data to a user.

The node 102 can further include other measurement and data aggregators, such as instruments comprising GPU or advanced processing functionality used for training (formatting) local (private) artificial neural network (ANN) parameters, having subsequent outputs related to, but not limited to classification or regression.

The memory 120 of the node 102 can include a DUT library that stores associated DUT metadata, ANN outputs, and key validation data sets, transformed or raw, into searchable indices.

While the components of the node 102 are depicted as being external to test and measurement instruments 112, it will be appreciated by a person of ordinary skill in the art that any of these components can be integrated within the one or more test and measurement instruments 112. The components may couple to the test and measurement instrument 112 in any conventional manner, such as wired and/or wireless communication media and/or mechanisms.

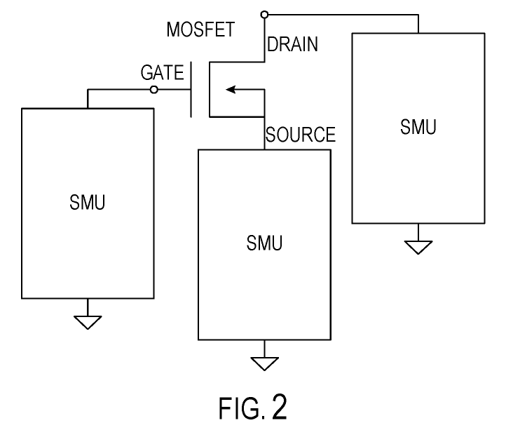

FIG. 2 is a diagram showing example test and measurement instruments coupled to a DUT for the node 102 of FIG. 1, according to some examples. The nodes 102 may have any number of test and measurement instruments as needed to perform testing and measurements on the DUT 110. The test and measurement instrument may comprise a “compound” instrument, meaning that the instrument comprises two different instruments. In some examples, a node 102 may have any combination of different instruments, such as a source measure unit (SMU) and an oscilloscope or multiple SMUs. As illustrated, SMUs can be used to measure electrical, optical, acoustic or thermal parameters related to Semiconductor testing, and testing is used to ascertain yield, i.e., factors for determining if the device under test (DUT) should move to the next phase of testing.

Further, the nodes 102 may have any combination of test and measurement instruments for testing and performing measurements on the DUT 110. As illustrated in FIG. 2, a node 102 can have three test and measurement instruments, such as SMUs as shown, coupled to a DUT.

While FIG. 2 shows the DUT to be tested and measured is a transistor, the DUT 110 of FIG. 1 can be any type of device to be tested and may be coupled to the test and measurement instruments 112 of the node 102 of FIG. 1 in any arrangement to complete testing and measurement.

Referring back to FIG. 1, the nodes 102 of the system 100 may have different or the same type of DUT 110; for example, two different nodes can have a transistor as a DUT, and another node can have a resistor as a DUT. Along the same line of thought, the nodes 102 can have any number and/or any combination of AI models 116, such as a CNN or an LLM, as needed to complete testing measurements.

The system 100 of FIG. 1 employs federated learning, where the base or “bootstrap” model of the one or more AI models 116 resides on most, if not all, of the system 100. Some nodes 102 in the system 100 may comprise transport or other types of nodes 102 that do not operate on inputs and outputs. These nodes 102 route data or handle other tasks that do not involve testing and measurement to the system 100.

As mentioned above, the nodes 102 in the system 100 that have the capability to participate in federated learning. In federated learning, each node 102 can operate independently and can thus independently generate and train their own respective AI models 116 based on their own DUT 110 and their own test and measurement instruments 112.

In some examples, the information from the nodes 102 can be broadcasted to other nodes 102 in the system 100 so that these other nodes 102 can be trained with external node information. Each other node 102 in the system 100 does the same, resulting in all nodes 102 in the system 100 that are operating GANs having at least the capability to update themselves to put all the nodes 102 into parity regarding their models 116. In some examples, different nodes 102 may have different federated learning policies in place that only accept selected updates and reject all others, or in the reverse, only reject certain updates but accept all others. In some examples, when nodes broadcast or share model updates, the updates are transmitted using secure aggregation protocols that prevent any receiving node or server from reconstructing individual node-level data. Additionally, updates may be encrypted in transit and at rest to prevent unauthorized access to device-specific characteristics or measurement data. In some examples, the nodes 102 may further employ privacy-preserving federated learning techniques, including secure aggregation of model parameters, encryption of data and model-update transmissions, and optionally differential-privacy mechanisms applied to locally computed updates, to ensure that raw DUT-level measurement data remains private to each node.

In some examples, the nodes 102 also transmit their updates to the central or main server(s) 104. Such communication may occur over authenticated and encrypted channels (e.g., TLS or hardware-root-of-trust secured links). In certain examples, the server 104 performs secure aggregation on the received updates before redistribution, ensuring that no party—including the server—can access raw or unmasked node-specific model parameters.

When a new node 102 comes into service in the system 100, the server(s) 104 may allow that node 102 to send or receive its one or more AI models 116. That node 102 may also receive the bootstrap model and then the updates, to allow the node to filter those updates that are not relevant to that node 102.

According to some examples of the disclosure, the system 100 collects data from DUTs of various nodes 102 of the system 100 and produces a bootstrap model (Model Zᵢ) of a device, Dᵢ , where i is on the order of millions. The data from the DUTs can be physical data at the manufacturing phase, data collected during testing and measurement, or any other data about the DUTs. The data collected from the DUTs can any number of measurements from the test and measurement instruments 112 regarding the DUT 110.

This model Zᵢ, in addition to metadata parameters, is associated with the manufactured device Dᵢ. Zi can be a model associated with an AI or ML algorithm that relies on input parameters (labels): X₀ through X_{N-1}. These input parameters form the input layers to the AI algorithm, which has an output, Yᵢ, as a predictive resultant. Yᵢ is the learned predictive estimate.

For the case i = 0, device D₀, model Z₀, and input parameters X₀ through X_{N-1}follow the DUT, becoming part of larger assemblies. The device, model, and input parameters are defined in a construct similar to, but not limited to, a Bill of Materials (BOM) list. For device D₀,parameter performance of X₀ through X_{N-1}is measured in a place in the workflow continuum and recorded by test and measurement instruments, if available, to confirm associated D₀ metadata. The test and measurement instrument with assistance from the processor measures the target resultant performance metric, Yᵢ. In some examples, Yᵢ is a metric related to a life-cycle function, e.g., reliability, and is characterized by physical measurement, e.g., current, voltage, or resistance. It should be understood that the Yi metric described herein is not limited to life-cycle or aging-related functions, but may encompass any performance metric relevant to the device under test (DUT). Together, X₀ through X_{N-1}and measured Yᵢ, are used to validate the predictive model Z₀ output through an error comparison. Validation and error comparison through optimization criterium is exemplified by, but not limited to, least squares (LS), minimum mean square error (MMSE), cross entropy, KL-divergence, triplet, margin loss, or any other loss functions associated with a ML algorithm. The overall system is trained to find minimal loss (error), ensuring Z₀ is the optimal representation of D₀ Life-Cycle behavior (metric). This validation of Z₀ through distributed data distribution uses federated learning to arrive at a stable model state, shared with both the Control and Design Life-Cycle participants, thereby improving the performance of life-cycle workflow steps apriori.

In some examples, the system 100 of FIG. 1 can be used in the semiconductor manufacturing context. In such examples, semiconductor P-MOSFET parameters are used as metadata to train artificial neural networks based on measured electrical performance related to P-MOSFET. For example, as illustrated in FIG. 2, the system 100 uses SMUs to take terminal measurements for a DUT, such as a MOSFET, shown in FIG. 2. In some examples, the federated learning process maintains privacy of device-specific physical measurements by ensuring that only aggregated or differentially-private model updates contribute to the global model state.

Using circuitry (e.g., circuitry 114 of FIG. 1) including data converters, i.e. analog-to-digital converters (ADC), values are quantized to form input parameters used to train ANN to formulate predictions through regression analysis. These input parameters can include but are not limited to gate voltage sweep steps, drain current ranges, temperature, and time-under-stress. For example, an ANN input vector can use the following example dataset schema: Vector = [measurement₀, measurement₁, . . . measurement_{N-1}, temperature, humidity, time, AC power (Hz), AC RMS noise power]. These predictions correlate with a DUT lifetime performance, i.e. aging. In some examples, the predictions can correlate with any DUT performance metric.

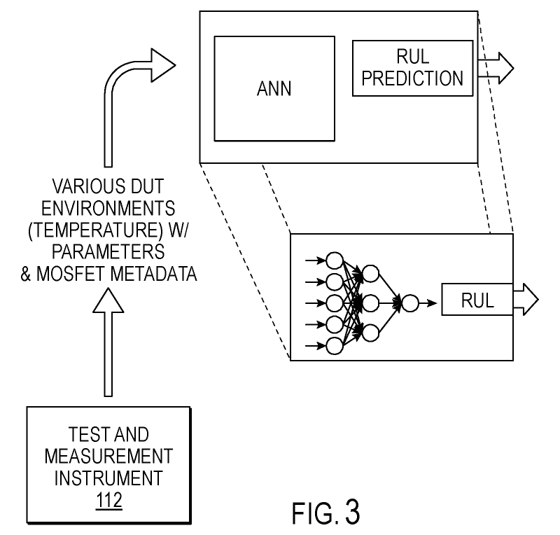

FIG. 3 is a diagram showing a topology for the artificial intelligence-based system 100 of FIG. 1, according to some examples.

As illustrated in FIG. 3, the test and measurement instrument 112 of the AI-based system 100 of FIG. 1 generates DUT measurement data, as previously described. As previously described, this DUT measurement data can be pre-processed and post-processed as needed (e.g., via circuitry 114 of FIG. 1), and can be used a parameters for an ANN model.

In this topology, the parameters of the ANN model (weights and biases) are transferred between the test and measurement instruments (edge sensors) and central collection points that act as aggregators for both AI model parameters and data, such as memory 120 of FIG. 1 or server 104 of FIG. 1. Examples of the disclosure exclusively employ both distributed and federated learning. Examples may use techniques similar to those described in U.S. Pat. App. Pub. No. 2024/0288540, published Aug. 29, 2024, the contents of which are hereby incorporated by reference.

In some examples, the resultant ANN model parameters, net definitions, and representative validation data sets are associated with metadata related to the DUT semiconductor parameters to form a unique DUT characteristic profile, an entry in a larger collection of DUT with like metadata parameters.

Resultants from the ANN are shared to enhance semiconductor design tools or operational planning. For example, as shown in FIG. 3, an example resultant from the ANN is a Reliable Usable Lifetime (RUL) prediction for a particular set of parameters as set forth by a semiconductor design tool. In some examples, the resultants are used to modify the design parameters of the DUT, which include but are not limited to channel length, oxide thickness, duty cycle, derating factor.

Another example of the present disclosure involves electron migration accelerated life testing. With such testing, the temperature plateau is set for the DUT and the SMU used to drive current, at controlled current densities, to “stress” traces measuring for delamination from substrates. Measurements are used to train the ANN model, which is federated (shared) to other nodes and/or electronic design automation (EDA) tools. These EDA tools can drive better designs through test, measures, and sustainment by instrumentation that relays information for continuous improvement and continuous development ML processing.

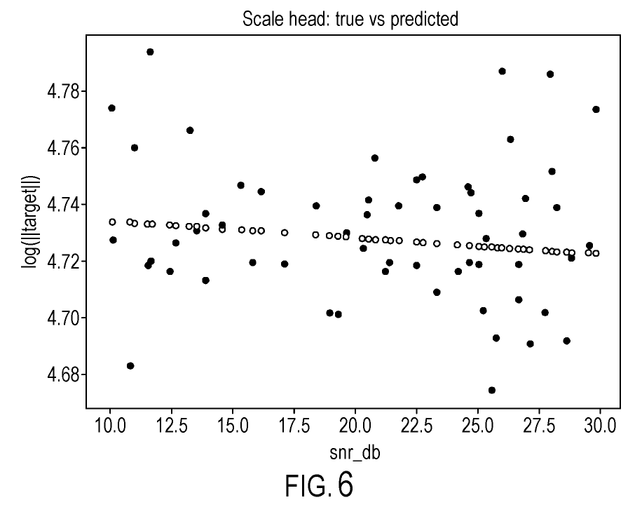

As shown in FIG. 6, predictive assessments can be determined. RUL target voltage performance form distributed learned models based on ac power root mean square (rms) noise, expressed in sound to noise ratio (measured in decibels)(snr_db). The graph of FIG. 6 illustrates the predicted points, which are empty points on the graph, compared to the true measurements, which are represented by the solid points on the graph.

In some examples, groups of nodes can be used to refine a single AI model shared amongst the nodes of the group. In such examples, the nodes of a group can all include the same type of DUT but may have the same or different types of test and measurement instruments depending the input parameters for the AI model. The nodes together work to generate and train a single AI model shared amongst the nodes for the respective type of DUT shared by the nodes. In such examples, the nodes can transmit updates to the AI model to each other to ensure that each of the nodes with the corresponding DUT type has the most updated version of the AI model.

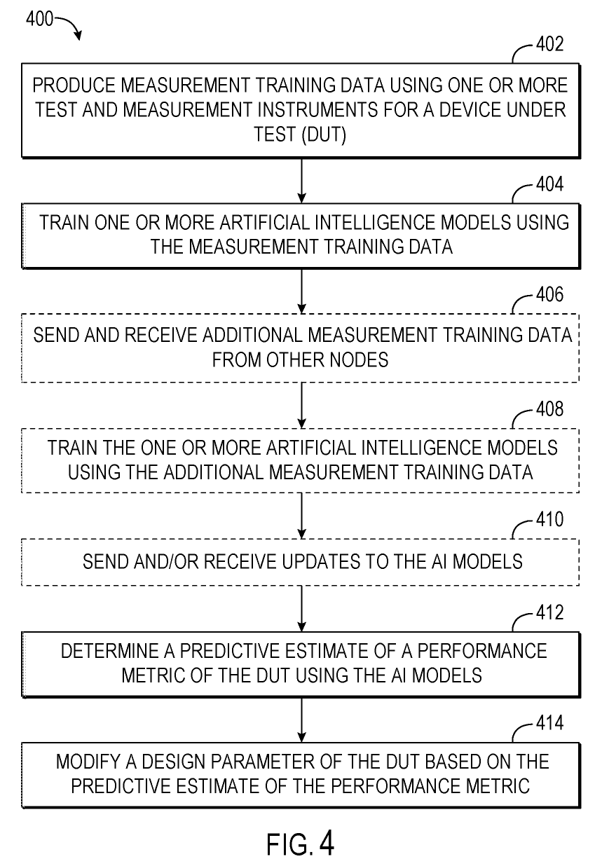

FIG. 4 is a flowchart of operations performed by a node of the distributed federated system 100 of FIG. 1, according to some examples. In some examples, one or more process blocks of FIG. 4 may be performed by a node (e.g., node 102 of FIG. 1) or a computing device of the node having a processor (e.g., processor 118 of FIG. 1) and memory (e.g., memory 120 of FIG. 1) coupled to one or more test and measurement instruments (e.g., test and measurement instruments 112 of FIG. 1), which in turn is coupled to a device under test (e.g., DUT 110 of FIG. 1). Accordingly, for process 400 of FIG. 4, reference to actions performed by the node may also be performed by other parts of the node as described herein.

As shown in FIG. 4, process 400 may include producing measurement training data using one or more test and measurement instruments for a DUT (block 402). For example, the node may produce measurement training data using one or more test and measurement instruments for DUT, as described above. In some examples, the processor of the node may instruct the test and measurement instrument(s) to drive, test, and measure corresponding measurement data for the DUT. The measurement training data may include any currents, voltage, resistances, and/or any other technical specification for the DUT.

As also shown in FIG. 4, process 400 may include training one or more artificial intelligence (AI) models (e.g., AI model 116) using the measurement training data (block 404). For example, a node may train one or more artificial intelligence (AI) models using the measurement training data, as described above. In some examples, the processor of the node may instruct a dedicated processor for the one or more AI models to use the measurement training data from the test and measurement instruments to train the one or more AI models.

In some examples, process 400 may include sending and/or receiving additional measurement training data from other nodes (block 406) and training the one or more AI models using the additional measurement training data (block 408). As mentioned previously, other nodes of the distributed federated learning system may also be producing training data from their respective DUTs via their respective test and measurement instruments. Accordingly, nodes can send and/or receive measurement training data from other nodes to further train the AI models of their respective nodes.

In some examples, process 400 may include sending and/or receiving updates to the AI models (block 410). As mentioned, with distributed federated system 100 of FIG. 1, nodes of the distributed federated system as described herein can each generate and train their own respective AI models, and so, the nodes can send and/or receive these updates to the AI models from other nodes that are training models for their respective type of DUT. In some examples, sending and/or receiving updates to AI models is limited based on the type of DUT of the respective node.

As further shown in FIG. 4, process 400 may include determining a predictive estimate of a performance metric of the DUT using the one or more AI models (block 412). For example, the node may determine a predictive estimate of a performance metric of the DUT using the one or more AI models, as described above.

As also shown in FIG. 4, process 400 may include modifying a design parameter of the DUT based on the predictive estimate of the performance metric (block 414). For example, the node may modify a design parameter of the DUT based on the predictive estimate of the performance metric, as described above. In some examples, the process 400 can includes making a decision about how to disposition (e.g., pass, fail, binning) the DUT based on the predictive estimate of the performance metric.

Process 400 may include additional implementations, such as any single implementation or any combination of implementations described below and/or in connection with one or more other processes described elsewhere herein. In a first implementation, the one or more test and measurement instruments may include a source measure unit.

In some examples, the measurement training data is a first set of measurement training data, the DUT is a first DUT, and the method further may include: receiving a second set of measurement training data from a node of the test and measurement system, where the node may include a second DUT and the second set of measurement training data corresponds to measurements from the second DUT; and training the one or more AI models with the second set of measurement training data.

In some examples, process 400 further includes transmitting the one or more AI models trained with the second set of measurement training data to another node of the test and measurement system.

In some examples, the performance metric is a life cycle metric of the DUT, and where the measurement training data may include current measurements, voltage measurements, and resistance measurements.

Although FIG. 4 shows example blocks of process 400, in some examples, process 400 may include additional blocks, fewer blocks, different blocks, or differently arranged blocks than those depicted in FIG. 4. Additionally, or alternatively, two or more of the blocks of process 400 may be performed in parallel.

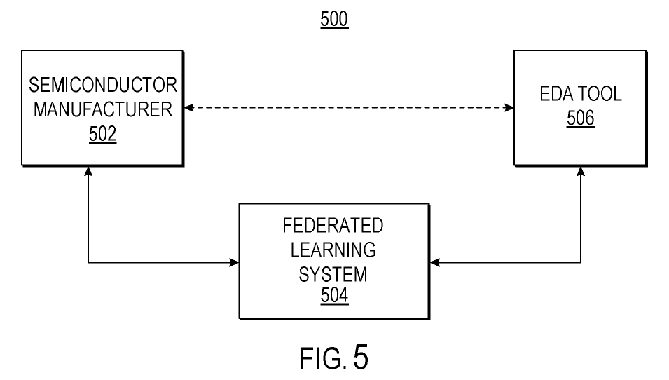

FIG. 5 is a block diagram of the environment of a distributed federated system as described herein, according to some examples. In the context of semiconductor manufacturing and testing and measurement thereof, the system 100 of FIG. 1 can be used as a distributed federated semiconductor test and measurement architecture. The environment 500 of FIG. 5 includes a semiconductor manufacturer 502, the federated learning system 504 as described herein, and an electronic design automation (EDA) tool 506. Since this example environment is set in a semiconductor manufacturer context, the environment includes the semiconductor manufacturer 502 and the EDA tool 506. However, the use of the distributed federated system as described herein is not limited to the semiconductor manufacturing context and can be used in other contexts. Accordingly, the semiconductor manufacturer 502 and the EDA tool 506 can be different information providers and tools using predictive analytics, respectively.

The semiconductor manufacturer 502 can be any provider of information used in this context. Because this environment is set in a semiconductor manufacturing context, the semiconductor manufacturer provides semiconductor information to the federated learning system 504. In some examples, the semiconductor manufacturer 502 can act as either the server 104 of the system 100 as shown in FIG. 1, or as a group of nodes 102 of the system 100 as shown in FIG. 1.

The semiconductor manufacturer 502 passes information to the federated learning system 504 as described herein, and the federated learning system 504 processes the information as described herein and is able to provide predictive information to the EDA tool 506. The EDA tool 506 can be used by the semiconductor manufacturer 502 to design new semiconductors and make predictions regarding the newly designed semiconductors using the federated learning system 504 as described herein.

In some examples, the semiconductor manufacturer 502 can communicate with EDA tool 506 which can indicate that there is feedback between the semiconductor manufacturer 502 and the EDA tool 506 for incorporating real and/or measured data from the EDA tool outputs and for further refining the model via the federated learning system 504. The communication between the semiconductor manufacturer 502 and the EDA tool 506 shown in FIG. 5 represents the link created by the physical device design data generated by the EDA tool 506, which the semiconductor manufacturer 502 can use to fabricate new physical devices, which can then be tested to generate data to evolve and refine the device model of the federated learning system 504. Accordingly, the communication channels between the semiconductor manufacturer 502, the federated learning system 504, and the EDA tool 506 provide automation and a full-closed loop converged model, further leading to continuous improvement or continuous deployment based on more and broader data being used to train the federated learning system 504.

Overall, examples of the disclosure delve into the transformative potential of distributed and federated learning in the advancement of Artificial Intelligence-driven Process Design Kits (PDKAI) for semiconductor manufacturing. The present disclosure harnesses the power of machine learning (ML) to construct sophisticated regression models that are informed by critical semiconductor (SI) parameters. The primary objective of these ML-driven regression outputs is to refine design workflows by offering predictive insights into the life-cycle outcomes of semiconductor devices. Notably, this includes enhancing Accelerated Life Assessments (ALA), which are crucial for evaluating the longevity and reliability of semiconductor components.

Integrating these advanced models into AI paves the way for the automated generation of scalable and integrable code within future EDA tools. This approach not only streamlines the design process but also ensures that engineers have access to high-quality predictive modeling resources.

At present, leading-edge implementations typically utilize Verilog-A in the creation of PDKs that establish a connection between semiconductor processes and EDA vendors. Designers rely on these PDKs within conventional EDA simulation environments, which fosters a close-knit relationship between process capabilities and EDA tools. However, the evolving landscape of AI applications demands a greater variety of data, and maintaining a continuous supply of such data introduces significant challenges to this established framework. Therefore, the present disclosure advocates for a disaggregated test and measurement platform approach that facilitates data sharing while simultaneously safeguarding proprietary information from SI process vendors. This balance is essential for fostering collaboration within an industry while protecting competitive advantages.

To train high-performance candidate ANNs capable of predicting DUT metrics— such as the RUL of semiconductor devices, including P-MOSFETs—the described methodology employs a disaggregated test and measurement architecture. This architecture comprises edge sensing technologies combined with GPU processing capabilities. By implementing this approach, foundry users can optimize their designs for yield and performance through in-situ measurements taken during the early stages of the semiconductor workflow. As a result, this initiative enhances real-time performance in impending EDA systems augmented with PDKAIs, adding substantial value surpassing conventional PDKs.

The value of this innovation relates to delivering comprehensive results that underscore the critical factors regarding the need for data precision, solving the ramifications of data accessibility, and ensuring consistent evaluations of predictive model quality. These insights contribute to the discourse surrounding establishing standards and interfaces that are pivotal for creating a collaborative ecosystem benefiting EDA systems, semiconductor process vendors, and future semiconductor designers.

The foregoing description of the invention has been set merely to illustrate the invention and is not intended to be limiting. Since modifications of the disclosed examples incorporating the substance of the invention may occur to person skilled in the art, the invention should be construed to include everything within the scope of the invention.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement system, including: a network; a plurality of nodes coupled to the network, each node may include: a device under test (DUT); one or more test and measurement instruments; one or more artificial intelligence (AI) models; one or more processors configured to execute code to cause the one or more processors to: produce measurement training data using the one or more test and measurement instruments for the DUT; train the one or more AI models using the measurement training data; and determine a predictive estimate of a performance metric of the DUT using the one or more AI models.

Example 2 is the test and measurement system of Example 1, where each node further may include one more databases in communication with the one or more AI models.

Example 3 is the test and measurement system of Example 1 or Example 2, where the one or more test and measurement instruments may include a source measure unit.

Example 4 is the test and measurement system of any one of Example 1-3, where the one or more AI models may include an artificial neural network.

Example 5 is the test and measurement system of any one of Example 1-4, where the one or more DUTs may include a transistor.

Example 6 is the test and measurement system of any one of Example 1-5, where the measurement training data may include physical measurements of the DUT.

Example 7 is the test and measurement system of any one of Example 1-6, where the model is further trained through regression analysis.

Example 8 is the test and measurement system of any one of Example 1-7, where the measurement training data is a first set of measurement training data and the one or more processors of each node is further configured to execute code to cause the one or more processors to: transmit and receive a second set of measurement training data from at least one other node of the test and measurement system; and train the one or more AI models with the second set of measurement training data.

Example 9 is The test and measurement system of any one of Example 1-8, where the one or more processors of each node is further configured to execute code to cause the one or more processors to: transmit the one or more AI models trained with the second set of measurement training data to another node of the test and measurement system.

Example 10 is the test and measurement system of any one of Example 1-9, where the one or more processors of each node is further configured to execute code to cause the one or more processors to: update one or more design tools for the DUT using the one or more AI models.

Example 11 is the test and measurement system of any one of Example 1-10, where the one or more processors of each node is further configured to execute code to cause the one or more processors to: validate the one or more AI models using error comparison.

Example 12 is the test and measurement system of any one of Example 1-11, where the performance metric is a life cycle metric of the DUT.

Example 13 is the test and measurement of any one of Example 1-12, where the one or more processors of each node is further configured to execute code to cause the one or more processors to: form a unique DUT characteristic profile for the DUT.

Example 14 is a method for a test and measurement system, may include producing measurement training data using one or more test and measurement instruments for a device under test (DUT); train one or more artificial intelligence (AI) models using the measurement training data; determining a predictive estimate of a performance metric of the DUT using the one or more AI models; and modify a design parameter of the DUT based on the predictive estimate of the performance metric

Example 15 is the method of Example 14, where the one or more test and measurement instruments may include a source measure unit.

Example 16 is the method of Example 14 or Example 15, where the one or more AI models may include an artificial neural network.

Example 17 is the method of any one of Example 14-16, where the one or more DUTs may include a transistor.

Example 18 is the method of any one of Example 14-17, where the measurement training data is a first set of measurement training data, the DUT is a first DUT, and the method further may include: receiving a second set of measurement training data from a node of the test and measurement system, where the node may include a second DUT and the second set of measurement training data corresponds to measurements from the second DUT; and training the one or more AI models with the second set of measurement training data.

Example 19 is the method of any one of Example 14-18, further may include: transmitting the one or more AI models trained with the second set of measurement training data to another node of the test and measurement system.

Example 20 is the test and measurement system of any one of Example 14-19, where the performance metric is a life cycle metric of the DUT, and where the measurement training data may include current measurements, voltage measurements, and resistance measurements.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of the disclosure have been illustrated and described for purposes of illustration, it will be understood that various modifications may be made without departing from the spirit and scope of the disclosure.

What is claimed is:

1. A test and measurement system, comprising:
a network;
a plurality of nodes coupled to the network, each node comprising:
a device under test (DUT);
one or more test and measurement instruments;
one or more artificial intelligence (AI) models;
one or more processors configured to execute code to cause the one or more processors to:
produce measurement training data using the one or more test and measurement instruments for the DUT;
train the one or more AI models using the measurement training data; and
determine a predictive estimate of a performance metric of the DUT using the one or more AI models.

2. The test and measurement system of claim 1, wherein each node further comprises one more databases in communication with the one or more AI models.

3. The test and measurement system of claim 1, wherein the one or more test and measurement instruments comprises a source measure unit.

4. The test and measurement system of claim 1, wherein the one or more AI models comprises an artificial neural network.

5. The test and measurement system of claim 1, wherein the one or more DUTs comprises a transistor.

6. The test and measurement system of claim 1, wherein the measurement training data comprises physical measurements of the DUT.

7. The test and measurement system of claim 1,wherein the model is further trained through regression analysis.

8. The test and measurement system of claim 1, wherein the measurement training data is a first set of measurement training data and the one or more processors of each node is further configured to execute code to cause the one or more processors to:
transmit and receive a second set of measurement training data from at least one other node of the test and measurement system; and
train the one or more AI models with the second set of measurement training data.

9. The test and measurement system of claim 8, wherein the one or more processors of each node is further configured to execute code to cause the one or more processors to:
transmit the one or more AI models trained with the second set of measurement training data to another node of the test and measurement system.

10. The test and measurement system of claim 1, wherein the one or more processors of each node is further configured to execute code to cause the one or more processors to: update one or more design tools for the DUT using the one or more AI models.

11. The test and measurement system of claim 1, wherein the one or more processors of each node is further configured to execute code to cause the one or more processors to: validate the one or more AI models using error comparison.

12. The test and measurement system of claim 1, wherein the performance metric is a life cycle metric of the DUT.

13. The test and measurement of claim 1, wherein the one or more processors of each node is further configured to execute code to cause the one or more processors to: form a unique DUT characteristic profile for the DUT.

14. A method for a test and measurement system, comprising
producing measurement training data using one or more test and measurement instruments for a device under test (DUT);
train one or more artificial intelligence (AI) models using the measurement training data;
determining a predictive estimate of a performance metric of the DUT using the one or more AI models; and
modify a design parameter of the DUT based on the predictive estimate of the performance metric

15. The method of claim 14, wherein the one or more test and measurement instruments comprises a source measure unit.

16. The method of claim 14, wherein the one or more AI models comprises an artificial neural network.

17. The method of claim 14, wherein the one or more DUTs comprises a transistor.

18. The method of claim 14, wherein the measurement training data is a first set of measurement training data, the DUT is a first DUT, and the method further comprises:
receiving a second set of measurement training data from a node of the test and measurement system, wherein the node comprises a second DUT and the second set of measurement training data corresponds to measurements from the second DUT; and
training the one or more AI models with the second set of measurement training data.

19. The method of claim 18, further comprising:
transmitting the one or more AI models trained with the second set of measurement training data to another node of the test and measurement system.

20. The test and measurement system of claim 14, wherein the performance metric is a life cycle metric of the DUT, and wherein the measurement training data comprises current measurements, voltage measurements, and resistance measurements.
